(19) United States
(12) Patent Application Publication
(10) Pub. No.: US 2012/0116834 A1
(43) Pub. Date: May 10, 2012

(54) HYBRID TASK BOARD AND CRITICAL PATH METHOD BASED PROJECT APPLICATION

(75) Inventors: Alexander Pope, Seattle, WA (US); Jonathan Kaufthal, Seattle, WA (US)

(73) Assignee: MICROSOFT CORPORATION, Redmond, WA (US)

(21) Appl. No.: 12/941,864

(22) Filed: Nov. 8, 2010

(51) Int. Cl. G06Q 10/00

(52) U.S. Cl. 705/7.26

(57) ABSTRACT

Tasks can be visualized and tracked through automatic generation of a task board based on data from a project management application and data transferred from a task board to a project management application. Summary tasks, which represent grouping of related tasks in project management, are pivoted such that sub-tasks can be laid out in task board rows or “stories.” Progress status indicators in a task board (or columns) are derived automatically from intrinsic and traditional project management application fields like “percent complete” enabling users to take advantage of traditional project management features such as dependencies, resource leveling, etc., while presenting a simplified and intuitive task board interface to a project manager and/or a project team.

### BACKGROUND

Many operations of business or non-business organizations may be defined and structured as projects. Within a structured project, designated people may develop plans, assign resources to tasks, track progress, manage budgets, and analyze progress/workloads. Project management applications enable users to create critical path schedules and resource allocations in a manual, automated, or semi-automated manner. Schedules, resource allocations, and other aspects of the projects may be visualized in different ways such as Gantt charts. Some project management applications also provide additional views such as calendars, tables, etc. Typical project management applications are relatively complex programs that can interact with other applications like Enterprise Resource Planning (ERP) applications to integrate project management with other aspects of the organizations such as inventory, marketing, customer service, and similar ones.

Task boards may be viewed as a basic version of project management tools. A typical task board includes a listing of tasks in a hierarchically structured manner and their progress status. A variety of additional features and complexities may be added to task boards, but their basic functionality is to provide an overview of relevant tasks and their status to a user. A majority of task board applications are standalone applications that visualize manually input task and status data. Even if the data is obtained from a source such as a database, there is usually no coordination between a task board application and a comprehensive project management application.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to visualization and tracking of tasks through automatic generation of a task board based on data from a project management application and transfer of data from a task board to a project management application. According to some embodiments, summary tasks, which represent grouping of related tasks in project management, may be pivoted such that sub-tasks can be laid out in task board rows or “stories.” Progress status indicators in a task board (or columns) may be derived automatically from intrinsic and traditional project management application fields like “percent complete” enabling users to take advantage of traditional project management features such as dependencies, resource leveling, etc., while presenting a simplified and intuitive task board interface to the project team.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example networked environment, where a project based task board according to embodiments may be implemented;

FIG. 2 illustrates an example task board screenshot;

FIG. 3 illustrates an example user interface for manually adjusting task properties on a task board according to some embodiments;

FIG. 4 illustrates another example task board screenshot;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of creating a hybrid task board based on a critical path method based project system according to embodiments.

### DETAILED DESCRIPTION

As briefly described above, tasks may be visualized and tracked through automatic generation of a task board based on data from a critical path method based project application. Sub-tasks may be laid out in task board rows or “stories” by pivoting summary tasks in a project management application. Progress status indicators on the task board (or columns) may be derived automatically from intrinsic and traditional project management application fields like “percent complete.” In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable storage media.

Throughout this specification, the term “platform” may be a combination of software and hardware components for critical path method based project systems. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

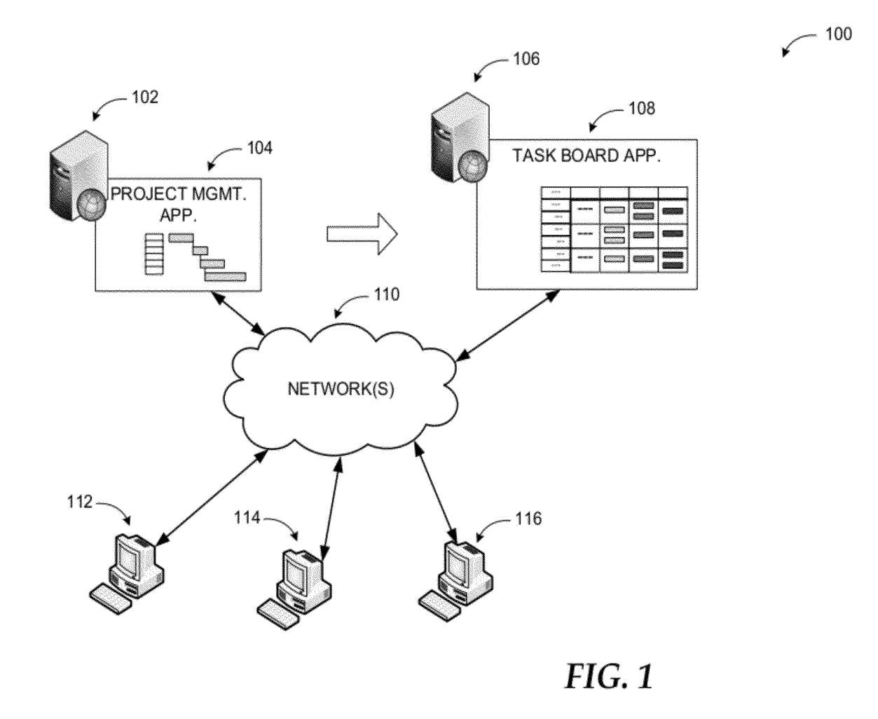

Referring to FIG. 1, a conceptual diagram 100 of an example networked environment, where a project based task board according to embodiments may be implemented, is illustrated. A task board application 108 executed on server 106 and/or a project management application 104 executed on server 102 may be part of a distributed (or centralized) system and provide one or more project management related services.

Project management application 104 executed on server 102 may enable users to create critical path schedules and resource allocations in a manual, automated, or semi-automated manner. Project management application 104 may compile data, analyze scenarios, and visualize various aspects of projects such as schedules, resource allocations, and similar ones using visual tools like Gantt charts, calendars, tables, and comparable ones. In a web service environment, users may access project management application 104 through client devices 112, 114, and 116 over one or more networks 110. Local access may be provided by locally installed rich clients (a local version of the project management application) or generic applications like browsers. Project management application 104 may be centrally provided (i.e. executed on one server) or in a distributed manner (i.e. a web based service executed on one or more servers).

Task board application 108 executed on server 106 represents a visual way to view and track task status. Task board application 108 may visualize tasks employing a grid of columns reflecting the state of a given task (e.g., not started, in progress, ready for testing signoff, completed, etc.) and rows representing aggregations of tasks (summary tasks, or “stories”), while the tasks themselves may be represented by graphical, textual, or combination of graphical and textual objects on the grid. Various graphical, textual, coloring, shading, and similar schemes may be employed to emphasize different aspects of displayed tasks, their status, and other properties. Similar to the project management application 104, task board application 108 may also be provided as a centrally or distributed hosted service and accessed by generic or rich client applications, or be a locally installed application.

Task board application 108 combines a task board with traditional critical-path method scheduling system data, enabling the same data to be represented and updated in either user interface. Thus, a traditional project outline (i.e., set of parent and sub-tasks in a hierarchy) may be transformed into a horizontal grouping of summary tasks (or “stories”) and sub-tasks. Furthermore, conventional and intrinsic project management fields such as percent complete may be used for automatic placement of specific tasks into appropriate columns on the task board.

As illustrated in the example environment of diagram 100, task board application 108 and project management application 104 may be distinct applications executed on different servers centrally or in a distributed manner. Alternatively, task board application 108 may be an integrated or add-on module of project management application 104. According to other embodiments, one or both of the applications may be locally executed (i.e. rich clients). According to further embodiments, one or both applications may be provided as part of a larger service, for example, a business tools service. Embodiments are not limited to these configurations, however. Other forms and configurations of providing a hybrid task board and critical path method based project application combination may be implemented using the principles described herein.

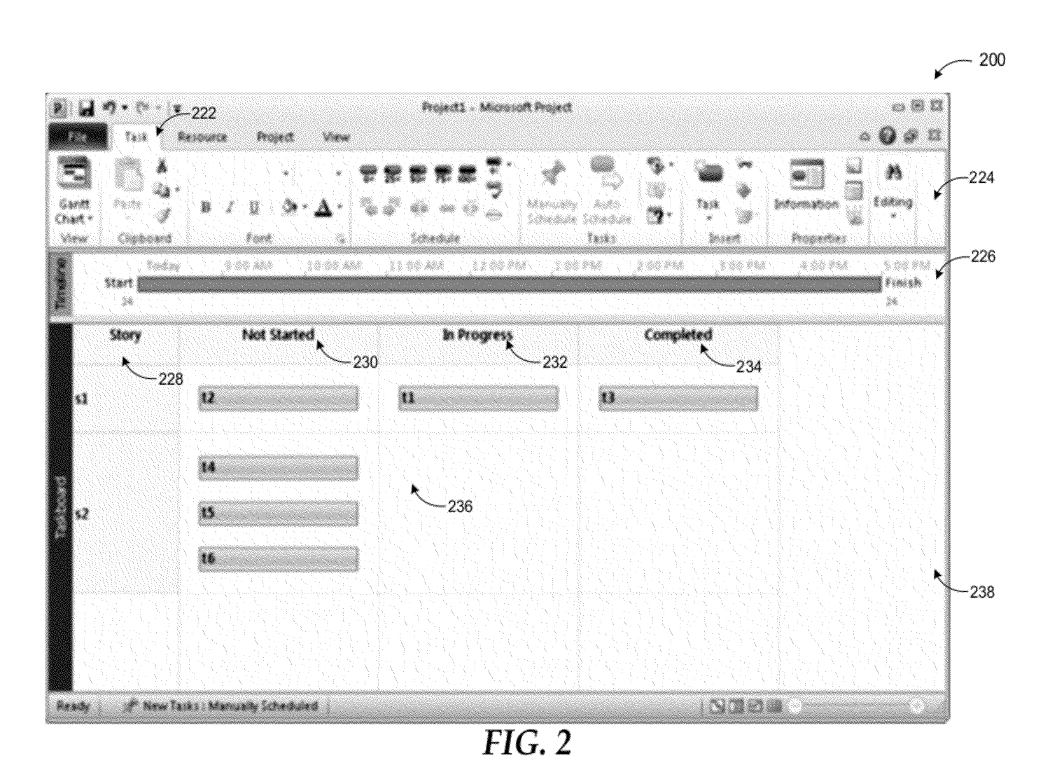

FIG. 2 illustrates an example task board screenshot. As discussed above, a task board may be provided by an independent application or a module within a project application. Screenshot 200 is an example of a task board provided as part of a project management application. Microsoft Project® by Microsoft Corporation of Redmond, Wash. is an example project management application that may be executed as a locally installed application or as a hosted service. Such a project management application may perform various entry, computation, analysis, and visualization operations associated with resources and projects. Different operation groups may be presented to a user through tabs on the user interface, for example, “task” tab 222. A control portion of the user interface 224 may provide various graphical and/or textual controls for performing different operations such as editing, copying, scheduling, and comparable ones.

An optional timeline portion 226 may present users time or date based temporal reference for the progress of tasks presented on the task board. Task board 238 may be presented in form of a grid with a first column representing stories 228 or summary tasks. A summary task may be defined as a task that has one or more child tasks. Summary tasks may have child tasks that are themselves summary tasks. A compilation of summary tasks may be referred to as a project. A child task may be any task that has no children reporting to it. Child tasks are also referred to as sub-tasks herein.

Additional columns in the grid may represent different status indicators such as “Not Started” 230, “In Progress” 232, “Completed” 234, and comparable ones. Individual tasks 236 may be dispersed in their respective rows (stories) and appropriate status columns. Various graphical and/or textual elements may be used to represent the tasks. Furthermore, the representations of the tasks (e.g., icons, objects, or text) may be actionable. For example, each representation may include a link to detailed data such as schedule, resources, designated person, or other project management views associated with the respective tasks.

In a system according to embodiments, elements of a conventional project management outline may be transformed into task board rows through a two-stage process: summary selection and sub-task selection. Summary selection may be performed in a variety of ways. According to one example implementation, rows (“stories”) may be determined by selecting summary tasks without parents (i.e., at the root level). Summary tasks may be selected also based on their respective outline level (e.g., summary tasks that each have a predefined number of parents), based on user selections, or based on a filter condition (e.g., summary tasks meeting a predefined description, starting date, duration, etc.).

Sub-task selection is the process of deciding which children (as well as grandchildren, great-grandchildren, and so forth) to display on the task board as individual tasks. These tasks may be displayed at the intersection of a row (summary task or story) and column (status). According to one example implementation, any sub-tasks underneath a summary task that are not summary tasks may be selected to be displayed. These tasks may also be referred to as “leaf nodes.” According to other embodiments, any tasks under a summary task may be selected (without the limitation of the first example selection method). Alternatively, any leaf node tasks that match a filter condition (for example, the above described criteria) may be selected to be displayed as well. Embodiments are not limited to these selection methods. Any combination of the discussed selection methods or others may be employed to determine summary tasks to be displayed in rows and sub-tasks to be displayed as tasks in the intersections of rows and status columns.

Thus, an algorithm for creating the task board may operate as follows. First, the list of tasks may be examined until a summary task that matches a predefined or user provided criterion is found. The examination may continue through the list until another summary task on the same level as the one selected is found (i.e., no more descendants). For every task visited, a determination may be made, whether the task matches a predefined or user provided criterion. If the task matches the criterion, it may be added to the story. The process may continue at the last node visited and proceed to the beginning until every task has been visited.

To place tasks into columns conventional project fields such as percent complete may be pivoted into appropriate columns on the task board such as “Not Started,” “In Progress,” and “Completed.” The status columns may be determined based on user selection of one or more predefined status categories, a default selection, or user definition for the categories. An automatic mapping may be performed to translate the project management fields to the status columns. For example, a zero in the percent complete field may be translated as “Not Started”, any value between 1 and 99 may be translated as “In Progress”, and a one hundred in the percent complete field may be translated as “Completed.”

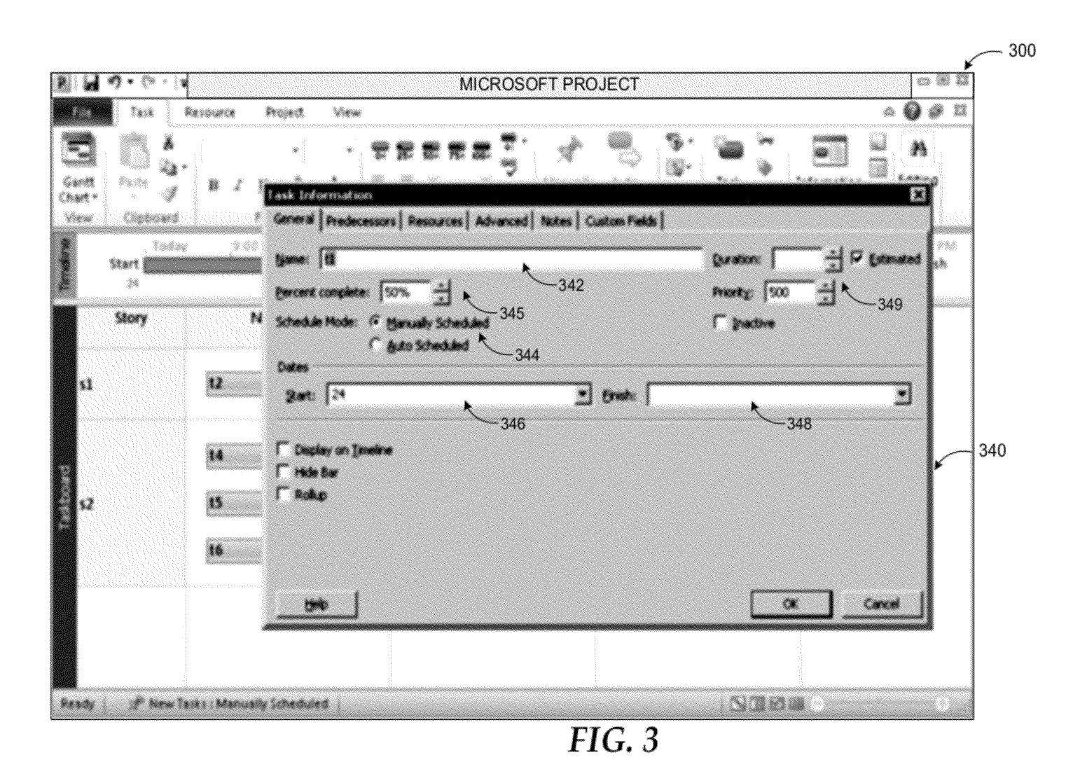

FIG. 3 illustrates an example user interface for manually adjusting task properties on a task board according to some embodiments. While the transformation of project information into a task board may be completely automatic according to some embodiments, a portion or all of the transformation related operations may also be performed manually according to other embodiments. The screenshot 300 in FIG. 3 illustrates user interface 340 over the screenshot 200 of a rich client application in FIG. 2 for user selection/entry of parameters associated with the task board creation.

A user may be enabled to select a particular task by selecting or entering a task name 342 on user interface 340. The user interface may be activated through selection of a task on a preliminary task board automatically created by the system or through selection of a control element (e.g., menu item, graphical control, etc.). Various parameters such as duration 349 of the selected task may be specified through user interface 340.

User interface 340 may also enable a user to specify whether the scheduling of the task is to be determined automatically or manually (344). If the task is to be scheduled manually, start (346) and end (348) dates/times may be specified by the user. A status of the task (345) may also be manually specified through the user interface 340. Different groupings of the operations associated with the task such as specification of its predecessors, identification of associated resources, etc. may be displayed in a tabbed manner on user interface 340. User interface may include additional selection/entry options for relevant parameters such as whether the task should be rolled up to a summary task, whether a timeline bar should be displayed, etc. If a graphical, textual, coloring, or similar scheme is used to display the task board, control options associated with the scheme may also be provided through user interface 340.

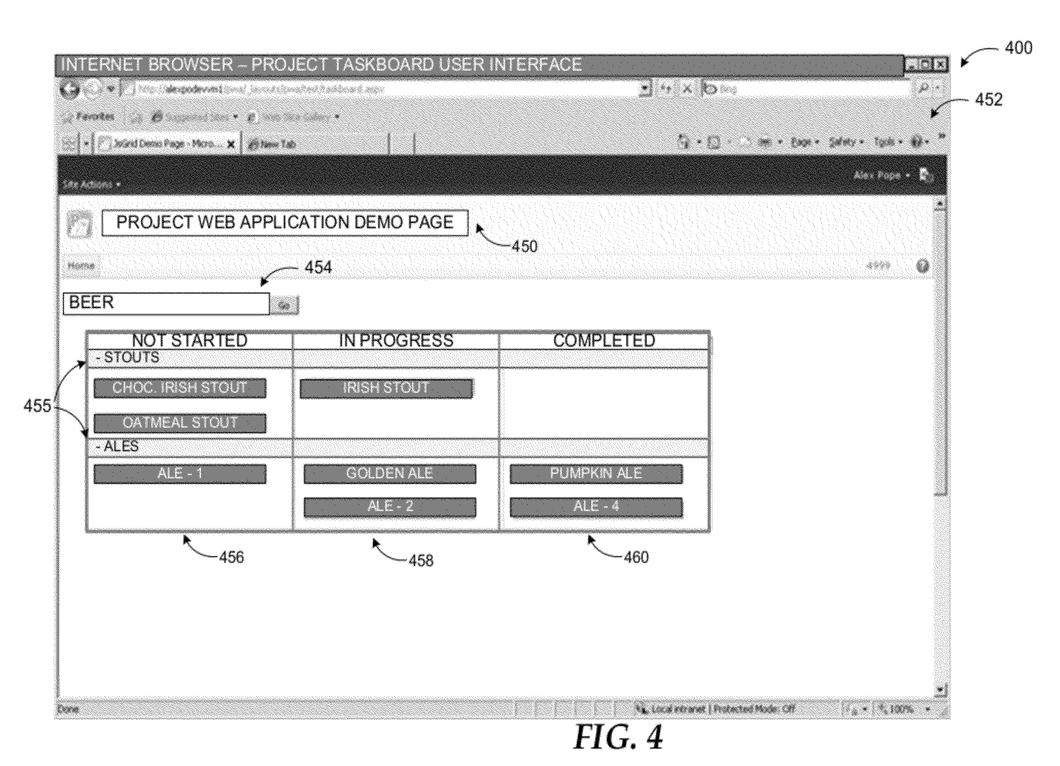

FIG. 4 illustrates another example task board screenshot. As discussed previously, a task board application may be a separate application executed locally or as a hosted service, which is accessed through a generic client application such as a browser. Screenshot 400 is an example of the latter scenario, where a browser may be used to access a task board application that creates a task board in conjunction with a critical path method based project application.

The browser of FIG. 4 includes conventional browser controls 452 (graphical and/or textual control elements). The displayed web page includes a title 450 identifying the task board. Differently from the task board of FIG. 2, the task board displayed on screenshot 400 does not display the stories or summary tasks in a separate column. The project associated with the task board is identified in project box 454, which may be a selectable drop-down menu style box or a textual entry box to enable users to select different projects. Summary tasks 455 are listed in the first status column 456 hierarchically distinguished from the tasks (or sub-tasks) in the same column. Other tasks for each summary task are displayed in their respective columns 458 and 460 following the same hierarchical tree scheme.

The tasks on screenshot 400 are displayed using graphical objects with textual identification. A coloring or shading scheme may be employed to further identify a property of each task (e.g., a sub-status such as percentage for “In Progress” tasks). Some or all of the displayed elements may be actionable providing links to controls associated with setting/modifying parameters associated with the tasks or modifying view settings.

As mentioned previously, the mapping of tasks statuses from project fields to task board columns may be performed in different ways. One example approach is using a predefined or user specified filter. The filter may comprise one or more rules. For example, a rule may indicate “tasks with zero percent complete and starting less than today are to be placed in a column titled To Do.” An algorithm facilitating the transformation may evaluate each task within each summary task to determine which column the task fits in based on the filter (rule or combination of rules) and add the task to the task board within its respective story.

According to some embodiments, the columns of the task board may be determined by a task property unrelated to status. For example, each task may have a field called “team”, with values like “Red Team”, “Green team”, etc. A task board may display these visually and enable them to be updated by the same drag-and-drop mechanisms discussed herein. Such a configuration is a hybrid critical path method based project system/task board because the data may also appear in the critical path method centric views of the project application.

The example applications, components, modules, data types, user interface elements, and interactions discussed in FIG. 2 through FIG. 4 are for illustration purposes only and do not constitute a limitation on embodiments. A hybrid task board and critical path method based project application may be implemented with other components, modules, data types, and configurations using the principles described herein.

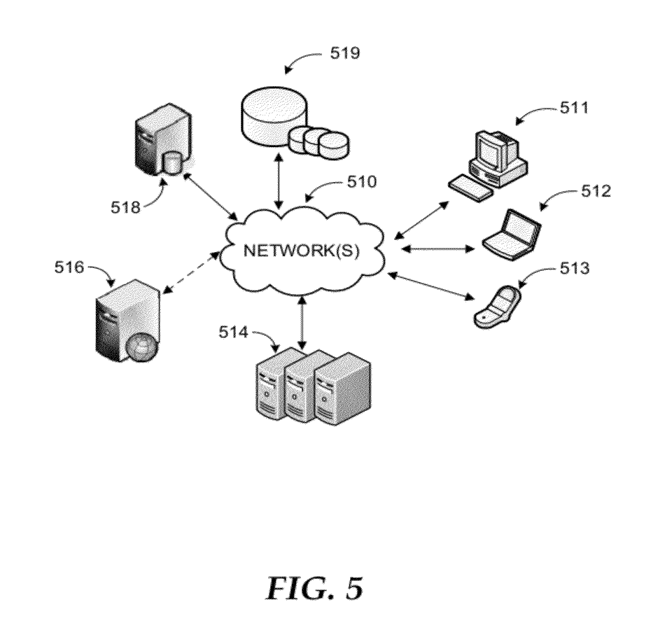

FIG. 5 is an example networked environment, where embodiments may be implemented. A platform providing task board and/or project management services may be implemented via software executed over one or more servers 514 or a single server (e.g. web server) 516 such as a hosted service. Alternatively, a task board application may be executed on server 516 and generate task board(s) based on project management data provided by a project management service executed on servers 514. The platform(s) may communicate with client applications on individual computing devices such as a smart phone 513, a laptop computer 512, or desktop computer 511 (client devices') through network(s) 510.

The task board application may visualize and track tasks by pivoting summary tasks, which represent grouping of related tasks in project management, and laying out sub-tasks on task board rows or “stories.” Progress status indicators on the task board (or columns) may be derived automatically from intrinsic and traditional project management application fields like “percent complete.” Data associated with the project management and/or task board operations may be stored directly or through database server 518 at data stores 519.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a hybrid task board and project management application in conjunction with a critical path method based project system. Furthermore, the networked environments discussed in FIG. 5 are for illustration purposes only. Embodiments are not limited to the example applications, modules, or processes.

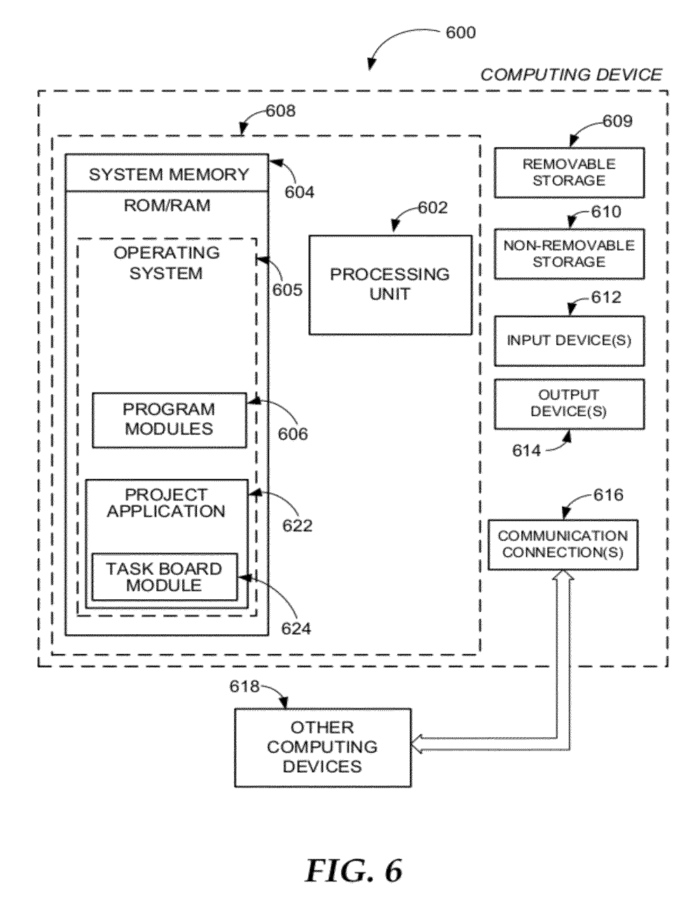

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a server or other computing device executing a project management and/or task board application and include at least one processing unit 602 and system memory 604. Processing unit 602 may have its own cache memory or use a dedicated portion of system memory 604 as cache. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, project management application 622, and task board module 624.

Project management application 622 may provide project management services enabling designated people to develop plans, assign resources to tasks, track progress, manage budgets, analyze progress/workloads, and so on. Task board module 624 may generate, update, and display a task board based on project data from the project management application 622 as discussed previously. Task board module 624 may be an integrated part of project management application 622, a separate application executed on the same computing device, or a separate application executed on a different computing device. Project management application 622 and task board module 624 may also be locally installed applications, distributed services, centralized services, or combinations of those. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that provide data storage services, consume data, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

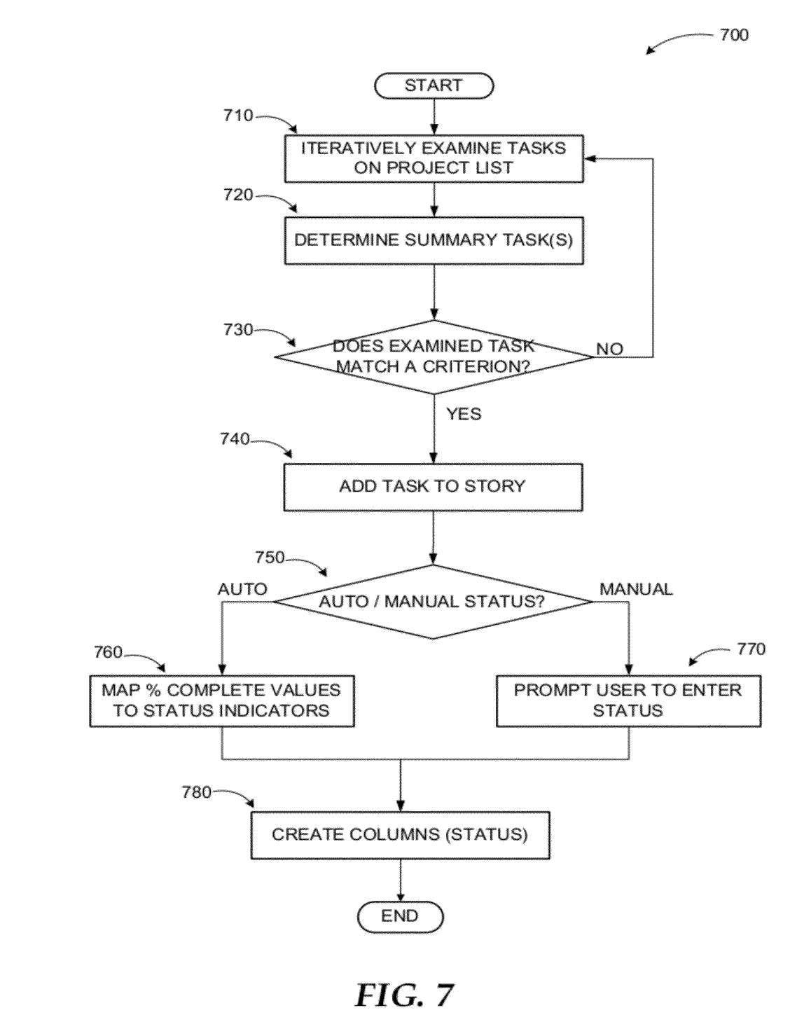

FIG. 7 illustrates a logic flow diagram for process 700 of creating a hybrid task board and a critical path method based project system according to embodiments. Process 700 may be implemented on a server or other computing device.

Process 700 begins with operation 710, where each task on a project list is examined in an iterative manner. Summary tasks may be determined at operation 720 based on a decision represented by operation 730 as to whether the examined task matches a predefined criterion. If the task does not match the criterion, the iterative examination may continue. If the task matches the criterion, the task may be added to the list of stories on the task board at operation 740.

Next, a determination may be made whether the status of each task is to be identified automatically or manually at decision operation 750. If the status is to be identified manually, the user may be prompted at operation 770 to enter or select a status for the task. If the status is to be determined automatically, relevant project field(s) may be mapped to status indicators (columns) on the task board at operation 760. According to some embodiments, the mapping may be a combination of automatic and manual (user prompt), for example, a default mapping may be suggested to the user automatically with the option of changing that default mapping. Thus, the status of a task may be determined based on automatic mapping, user selection of a predefined status category, a default selection, and/or a user defined status category. Following operations 760 and 770, the status columns may be created with the assigned tasks and the task board displayed.

The operations included in process 700 are for illustration purposes. A hybrid task board in conjunction with a critical path method based project system according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing a task board based on project management data, the method comprising:
selecting summary tasks among tasks within a project;
identifying child tasks associated with each summary task;
selecting tasks to be displayed on the task board among the identified child tasks;
determining a status of each task to be displayed on the task board; and
displaying the tasks to be displayed in a grid format, wherein summary tasks are displayed as rows, tasks are grouped under their respective summary tasks, and the tasks are placed in respective status columns.

2. The method of claim 1, further comprising:
selecting the summary tasks based on at least one from a set of: a respective outline level of each summary task within the project, a user selection, and a filter condition.

3. The method of claim 2, wherein the filter condition comprises at least one rule associated with a property of one of a summary task and a custom field.

4. The method of claim 3, wherein the at least one rule includes one of: a full description of a summary task, a partial description of a summary task, a starting date of a summary task, a starting time of a summary task, and a duration of a summary task.

5. The method of claim 1, further comprising:
selecting the tasks to be displayed based on at least one of: selecting any child tasks underneath a summary task that are not summary tasks and selecting any child tasks that match a predefined filter condition.

6. The method of claim 1, wherein determining a status of each task to be displayed includes:
determining a progress field value associated with each task within the project; and
automatically mapping the progress field value to a status column on the task board.

7. The method of claim 6, wherein the automatic mapping includes application of a filter condition comprising at least one rule.

8. The method of claim 7, further comprising:
enabling a user to provide status input for each task.

9. The method of claim 1, wherein the tasks are represented on the task board by actionable objects.

10. The method of claim 9, wherein the actionable objects provide a link to at least one from a set of: a data entry operation, an analysis operation, a computation operation, and a visualization operation.

11. A computing device providing a task board based on project management data, the computing device comprising:
a memory;
a processor coupled to the memory, the processor executing a task board application, the task board application performing actions including:
evaluate tasks from a project until a summary task that matches a criterion is determined;
for every evaluated non-summary task, determine whether the task matches another criterion;
if the evaluated non-summary task matches the other criterion, add the task to a list of tasks to be displayed on the task board;
for each task to be displayed, determine a status of the task based on at least one from a set of: automatic mapping, user selection of a predefined status category, a default selection, and a user defined status category; and
display the tasks to be displayed in rows associated with each summary task and in columns based on their respective status.

12. The computing device of claim 11, wherein a summary task is a task that includes at least one child task within the project and a non-summary task is a task that does not have any child tasks within the project, and the criterion for determining summary tasks is based on an outline level of each summary task within the project.

13. The computing device of claim 11, wherein the status of each task to be displayed is determined based on mapping a progress field value of the task within the project to a user defined status column employing at least one rule associated with a property of the task.

14. The computing device of claim 11, wherein the task board application is one of an integrated module and an add-on module of a project management application.

15. The computing device of claim 14, wherein the project management application is executed as one of: a centralized hosted service, a distributed hosted service, and a locally installed application.

16. The computing device of claim 14, wherein at least one of the task board application and the project management application are part of a hosted service and accessed through one of a locally installed rich client application and a generic client application.

17. The computing device of claim 11, wherein the task board application is a hosted service capable of retrieving project data from a critical path method based project service and accessible through a browser.

18. A computer-readable storage medium with instructions stored thereon for providing a task board based on project management data, the instructions comprising:
selecting summary tasks among tasks within a project based on at least one from a set of: a respective outline level of each summary task within the project, a user selection, and a filter condition;
identifying child tasks associated with each summary task;
selecting tasks to be displayed on the task board among the identified child tasks based on at least one of: selecting any child tasks underneath a summary task that are not summary tasks and selecting any child tasks that match a predefined filter condition;
determining a status of each task to be displayed on the task board by determining a progress field value associated with each task within the project and automatically mapping the progress field value to a status column on the task board; and
displaying the tasks to be displayed in a grid format, wherein summary tasks are displayed as rows, tasks are grouped under their respective summary tasks, and the tasks are placed in respective status columns.

19. The computer-readable storage medium of claim 18, wherein the tasks are displayed as actionable objects on the task board employing at least one from a set of: a graphical scheme, a textual scheme, a shading scheme, and a coloring scheme.

20. The computer-readable storage medium of claim 18, wherein the instructions further comprise:
providing a user interface for manual entry of at least one from a set of: a status, a duration, a start date, an end date, and a hierarchical position for a task to be displayed; and
modifying at least one automatically determined property of a task to be displayed on the task board based on the manual entry.
